(19) United States
(12) Patent Application Publication
(10) Pub. No.: US 2018/0138501 A1
(43) Pub. Date: May 17, 2018

(54) LEAD ACID BATTERY HAVING ELETRODES WITH FIBER MAT SURFACES

(71) Applicant: Trojan Battery Company, LLC, Santa Fe Springs, CA (US)

(72) Inventors: Marvin C. HO, Hammond, IN (US); Jesus Florencio Perez Lopez, Santa Fe Springs, CA (US)

(21) Appl. No.: 15/808,826

(22) Filed: Nov. 9, 2017

Related U.S. Application Data
(60) Provisional application No. 62/421,126, filed on Nov. 11, 2016.

(51) Int. Cl. H01M 4/20; H01M 4/68; H01M 10/06; H01M 4/56; H01M 4/66

(52) U.S. Cl. CPC H01M 4/20; H01M 4/68; H01M 2/1626; H01M 4/56; H01M 4/662; H01M 10/06

(57) ABSTRACT

Disclosed is an electrode for a lead acid battery formed of an electrode plate having a first side and a second opposing the first side, an active material paste applied to at least one of the first and second sides and a fiber mat embedded in the active material paste.

### CROSS-REFERENCE TO RELATED APPLICATIONS

This present application claims priority benefit under 35 U.S.C. § 119(e) from U.S. Provisional Application No. 62/421,126, filed Nov. 11, 2016, entitled “Lead Acid Battery Having Electrodes With Fiber Mat Surfaces.” The present application incorporates the entirety of the foregoing disclosure herein by reference.

### BACKGROUND OF THE INVENTION

### Field of the Invention

This invention relates to the chemical arts. In particular, this invention relates to lead acid battery components and a method for making the same.

### Background

A typical flooded lead-acid battery includes positive and negative electrodes immersed in an electrolyte. The electrodes are comprised of plates formed of grids primarily constructed of lead, often alloyed with antimony, calcium, or tin, to improve their mechanical characteristics. Antimony is generally a preferred alloying material for grids.

In a flooded lead-acid battery, positive and negative active material pastes are added to positive and negative electrode grids, forming positive and negative electrodes, respectively. The positive and negative active material pastes generally comprise lead oxide (PbO or lead (II) oxide). The electrolyte typically includes an aqueous acid solution, most commonly sulfuric acid. Once the battery is assembled, the battery undergoes a formation step in which a charge is applied to the battery in order to convert the lead oxide of the positive electrodes to lead dioxide (PbO₂ or lead (IV) oxide) and the lead oxide of the negative electrodes to lead.

After the formation step, a battery may be repeatedly discharged and charged in operation. During battery discharge, the positive and negative active materials react with the sulfuric acid of the electrolyte to form lead (II) sulfate (PbSO₄). By the reaction of the sulfuric acid with the positive and negative active materials, a portion of the sulfuric acid of the electrolyte is consumed. However, the sulfuric acid is regenerated upon battery charging. The reaction of the positive and negative active materials with the sulfuric acid of the electrolyte during discharge may be represented by the following formula:

Pb(s)+SO₄²⁻↔PbSO₄(s)+2e⁻ Reaction at the negative electrode:

PbO₂(s)+SO₄²⁻(aq)+4H⁺+2e⁻↔PbSO₄(s)+2(H₂O) Reaction at the positive electrode:

As shown by these formulae, during discharge, electrical energy is generated, making the flooded lead-acid battery a suitable power source for many applications. For example, flooded lead-acid batteries may be used as power sources for electric vehicles such as forklifts, golf cars, electric cars, and hybrid cars. Flooded lead-acid batteries are also used for emergency or standby power supplies, or to store power generated by photovoltaic systems.

As a result of repeated charge and discharge, active material can build up on top of the electrodes. This buildup is referred to as “moss” with the phenomenon referred to as “mossing.” In addition, the typical failure mode of positive active material (PAM) is material shedding (worn out) during cycling. Once most of materials are worn out, the battery cannot maintain performance (capacity) and reaches the end of life.

### SUMMARY OF THE INVENTION

Now, in accordance with one aspect of the invention, there has been found an electrode for a lead acid battery comprising an electrode plate having first and second opposing sides where a fiber mat is embedded in active material paste applied to at least one side of the electrode plate. And in one aspect, the lead acid battery is a flooded lead acid battery. In another aspect, the electrode plate having first and second opposing sides has a fiber mat embedded in active material paste applied to on both sides of the electrode plate. And in still another aspect, the electrode plate is a positive electrode plate and the active material is a positive active material.

In another aspect of the invention, an electrode for a lead acid battery having an electrode plate with first and second opposing sides is made by applying an active material to at least one of the opposing sides, placing a fiber mat on the active material and applying pressure to the fiber mat to embed the fiber mat in the active material and then curing the resulting electrode plate. And in one aspect, the lead acid battery is a flooded lead acid battery. In another aspect, the electrode for a lead acid battery having an electrode plate with first and second opposing sides is made by applying an active material to both of the opposing sides, placing a fiber mat on the active material on both sides and applying pressure to the fiber material to embed the fiber mat in the active material on both sides and then curing the resulting electrode plate. And in still another aspect, the electrode plate is a positive electrode plate and the active material is a positive active material.

### BRIEF DESCRIPTION OF THE DRAWINGS

FIGS. 1-3 illustrate placing a fiber mat onto the surface of a plate immediately after pasting.

FIGS. 4 and 5 illustrate using a roller to apply the fiber mat to the surface of a plate.

FIG. 6 illustrates the plate after curing.

### DETAILED DESCRIPTION OF THE INVENTION

A lead-acid battery comprises a positive electrode and a negative electrode separated by a separator and all immersed in an electrolyte. In one aspect of the invention, the positive electrode plate comprises a grid having first and second opposing sides to which a positive active material is applied. Similarly, the negative electrode is formed of a negative plate comprising a grid having first and second opposing sides to which a negative active material is applied. Now, there has been discovered a lead acid battery having a fiber mat embedded in active material paste applied to at least one of the first and second sides of one of the electrode plate. In one aspect, the lead acid battery is flooded lead acid battery. In one aspect, the plate is a positive plate and, in one aspect, a fiber mat is applied to both of the opposing sides of the positive plate.

Suitable fiber mats include fiberglass mats available from Johns Manville (Denver, Ohio). It is a distinct advantage of the invention that the fiber mats prevent mossing and positive active material shedding which will cause premature battery failure during cycling/field service

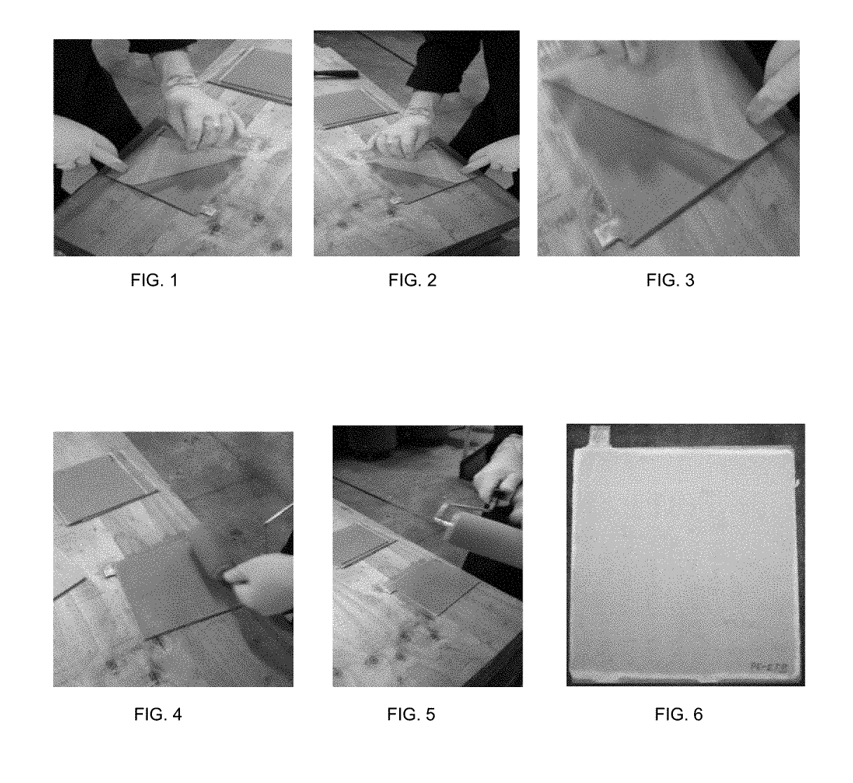

As illustrated in FIGS. 1-3, in one aspect of the invention, fiber mats having dimensions corresponding the surface of an electrode plate are placed on at least one of the opposing sides of the electrode plate to which an active material paste has been applied. (One side shown.) Then, in one aspect, as illustrated in FIGS. 4 and 5, after placing a fiber mat on one of the opposing surfaces of the plate to which an active material paste has been applied, pressure is applied by a roller to the exposed surface of the fiber mat to assure fiber mat penetrates (or embeds) into and adheres to active material.

After fiber mat is applied to at least one and, in some embodiments, both sides of the electrode plate to which an active material paste has been applied, the plate pate is cured. FIG. 6 illustrates the electrode plate after curing. Once the plates with at least one embedded fiber mat have been cured, the plates are ready to be used in a battery assembly process.

It is a distinct advantage of the invention that a fiber mat embedded in the active material paste applied to at least one of the first and second sides of a positive plate prevents or minimizes shedding and mossing issues from positive plates. During the charge/discharge cycling, the positive active material (PbO₂) will go through an expansion and shrinkage cycle. This is mainly due to the density changes of chemical materials between the states of charge (lead dioxide, PbO₂) and discharge (lead sulfate, PbSO₄). Without wishing to be bound by a theory of invention, it is believed that the fiber mats hold/maintain the active material on the positive plates adhered to the grids for longer time which results in longer battery life. Applying this special fiber mat to the surface of both sides of the plates keeps the active material tight and strong during the cycling and, thus, delays material shedding and minimize premature battery failure conditions after repeated cycling/field service. Furthermore, a fiber mat embedded in active material paste applied to at least one of the first and second sides of a negative plate prevents or minimizes acid stratification, dendrite creation, antimony deposition and the like in connection the negative plate.

We claim:

1. An electrode for a lead acid battery comprising:
an electrode plate having
a first side and a second opposing the first side;
an active material paste applied to at least one of the first and second sides; and
a fiber mat embedded in the active material paste.
